(19) United States
(12) Patent Application Publication
(10) Pub. No.: US 2005/0281921 A1
(43) Pub. Date: Dec. 22, 2005

(54) Multiple-option meal kit

(75) Inventors: Metty Langston, Buffalo Grove, IL (US); Michele Voss, Buffalo Grove, IL (US); Susan N. Breen, Naperville, IL (US); Scott Landy, Grayslake, IL (US); Indrayni N. Amladi, Princeton, NJ (US)

Correspondence Address: KRAFT / FETF, 120 S. LASALLE STREET, SUITE 1600, CHICAGO, IL, 60603-3406, US

(73) Assignee: Kraft Foods Holdings, Inc.

(21) Appl. No.: 10/872,067

(22) Filed: Jun. 18, 2004

(51) Int. Cl. A23B 4/00

(52) U.S. Cl. 426/120

(57) ABSTRACT

A meal kit for preparing at least two different distinct hot meals in which the meal kit comprises an outer container, a plurality of ingredients in individual containers placed within the outer container, and a set of instructions contained on or within the outer container describing at least two different ways of combining the plurality of ingredients to form at least two distinct hot meals, wherein different non-overlapping preparation times are associated respectively with the at least two different ways of combining the plurality of ingredients to make distinct hot meals. The meal kits provide savory, and conveniently and flexibly prepared, one-stop meal kits for consumers.

### FIELD OF THE INVENTION

This invention relates to meal kits, and, more particularly, relates to multiple-option meal kits permitting a consumer to select a meal among several meal options that can be made with the same ingredients, all of which are included within the meal kit, wherein the meal options have different respective preparation times to accommodate the time needs or preferences of a consumer.

### BACKGROUND OF THE INVENTION

There is a demand by consumers for meal kits from which meals can be prepared for consumption in a reduced amount of time. These prepared meals are manufactured and stored by a food retailer until purchased by a consumer, who may immediately consume the meal or store it for a period of time within the labeled shelf life of the product before consuming the meal. An often conflicting demand by consumers is that the prepared meals should be perceived as being “fresh.” For instance, many consumers expect that the foods in prepared meals be organoleptically similar to freshly made homemade meals as much as possible in terms of taste, aroma, and texture. For example, many consumers expect vegetables that are crisp, starches that are firm, flaky and not clumped, and meat that is tender, and so on, after storage of a prepared meal before its consumption.

Meal kits have been known for many years that are sold without the meat ingredient that require the consumer to separately obtain, store, add, and cook a meat ingredient together with other ingredients that are packaged and sold together with the meal kit. Such non-complete meal kits requiring consumers to separately procure and store the meat dish portion needed for the meal kit offer limited convenience to the consumer. Moreover, such prior meal kits offer only one type of meal option for preparation from the enclosed ingredients and non-enclosed or external meat ingredient.

Frozen prepared meals are also known. Frozen meals typically involve separate food servings filled into and frozen in serving trays of a container that are thawed and heated using a microwave or conventional convection oven. Many frozen meal components are significantly inferior in taste and appearance after cooking for consumption as compared to their refrigerated counterparts. For instance, microwaved frozen meals tend to have poor texture as the food components are limp or mushy, and otherwise lack crispness and freshness associated with homemade meals and foods cooked after refrigeration. Frozen meals that are baked often require a relatively long baking period as the food must be thawed or defrosted. In addition, baked frozen meals also tend to have deterioration in the texture and taste of the food components of the meal.

Refrigerated prepared meals, in general, have shorter shelf lives than comparable frozen meals including the same food components. However, any shorter shelf lives associated with refrigerated meals generally are not a concern for consumers due to more sophisticated product distribution and inventory management currently used by food manufacturers and food retailers. However, prior refrigerated meals have had limits on the convenience that they provide the consumers because they typically are packaged as a single type of meal with a single prescribed preparation time. At best, the packaging instructions may provide for different cooking times for a single type of meal depending on whether the single type of meal contained in the meal kit package is heated up by microwave or oven, and so forth. Commonly assigned U.S. Pat. No. 6,048,558 describes a refrigerated packaged ready-to-eat or ready-to-assemble precooked sandwich meal, which can be consumed in its refrigerated (i.e., non-reheated) condition or after the assembled sandwich is reheated in a microwave oven or the like.

However, a previously unappreciated and unfulfilled need has existed for meal kits that are both convenient and versatile such that consumers are provided multiple options for not only cooking times but also types of meals offered by a single meal kit which does not require the addition of a non-included food item. As will become apparent from the descriptions that follow, the present invention addresses this previously unmet need as well as provides other advantages and benefits.

### SUMMARY OF THE INVENTION

The present invention provides a multiple-option meal kit permitting a consumer to select from one of multiple meal choices provided by the same meal kit, wherein the multiple meal choices made available to the consumer from a common meal kit have different respective preparation times, as explained in instructions included with the meal kit. In this manner, the consumer who is preparing a meal using the meal kit can select a meal option that best fits with their time available or the time desired to be made available to prepare the meal. The meal kit thus gives the ultimate flexibility and choice to the consumer as it tailors to the meal preparer's desired time and efforts available for preparing the meal at that instance.

In one preferred embodiment, the meal kit of the present invention provides all these characteristics in a single packaged meal kit while eliminating requirements for addition of an extra food ingredient, such as a meat, not included with the meal kit in order to prepare the meals. Also, food waste is reduced, as all food components of a meal kit are used in each meal alternative that is supported by the meal kit. As such, the meal kit permits “one-stop” shopping for a savory meal by a consumer. The consumer enjoys a tasty meal while avoiding the inconvenience of having to prepare it from scratch or shop for additional ingredients needed to complete the meal kit.

In one embodiment, there is a meal kit for preparing at least two different distinct hot meals, in which the meal kit comprises an outer container, a plurality of ingredients in individual containers placed within the outer container, and a set of instructions contained on or within the outer container describing at least two different ways of combining the plurality of ingredients to form at least two distinct hot meals with different non-overlapping preparation times associated respectively with the at least two different ways of combining the ingredients, depending on the meal choice made by the consumer.

In one further embodiment, the instructions provide directions for preparing each of the at least two distinct hot meals using all of the plurality of ingredients in each of the at least two distinct hot meals. In this way, food waste is minimized, and the consumer is not faced with the task of storing unused ingredients of the meal kit after preparing any one of the meal options provided by it. In another further embodiment, the plurality of ingredients included in the meal kit can be combined in at least three different ways to form at least three distinct hot meals.

In one important embodiment, a meat component, such as substantially precooked chicken, beef or fish, is included in the meal kit. In this embodiment, a meat dish for the meal kit does not have to be separately purchased, stored, and cooked from scratch, which all adds to the convenience of the meal kit. In one embodiment, the meat component, and other food components included in the meal kit, are packaged in individual separate containers, such as flexible pouches, that have very low oxygen permeability and which are filled with the food component in a manner that reduces or flushes out entrapped air, such as with inert gas flushing or vacuum packaging. The individually packaged pouches of food are dimensioned such that they can be packed within a common container for ease of product handling, display and use.

In one embodiment, the multiple meal choices available and the respective preparation instructions for the two or more different types of meals that can be prepared from the collection of ingredients included in the same meal kit are provided for the consumer on an outside or inside surface of the container used to house the ingredients, or they are provided on a separate sheet of instructions included inside the container. The set of instructions, or portions thereof, also can be included on the ingredient packages. The instructions can be provided, for example, via print or labels.

As will be appreciated from the descriptions herein, the meal kits according to embodiments of this invention provide savory, and conveniently and flexibly prepared, meals for consumers.

In one particular embodiment, the plurality of ingredients included in the meal kit includes precooked meat, precooked vegetables, a starch product (e.g., rice, pasta, potatoes, and the like), cheese, sauce, and a bread product. In one further embodiment, the precooked meat is chicken, the starch product is rice, the sauce is salsa, and the bread product is flatbread, such as a tortilla.

The meal kits of the present invention can be packaged and stored under refrigerated or shelf-stable conditions until consumed. For purposes herein, a “shelf-stable” food refers to a packaged food item or items that are stably stored under room temperature conditions. In the instance of shelf-stable packaging of the meal kits of embodiments of this invention, a precooked meat ingredient, or other high moisture content ingredient(s), can be packed hermetically in cans or in gas-barrier plastic packaging materials for stable storage at room temperature conditions. For purposes herein, “refrigerated” generally means a food storage temperature of above 0 to about 7° C. In one particular aspect, the refrigerated food storage temperature used for storing refrigerated type meal kits of embodiments of this invention ranges from above 0 to about 4° C.

Methods of making and using the meal kits also are provided.

Other advantages and benefits of the present invention will become apparent from the detailed descriptions below, which make reference to the following figures.

### BRIEF DESCRIPTION OF DRAWINGS

FIG. 1 is a perspective view of a meal kit in accordance with one embodiment the invention in which individual food packages containing different meal ingredients are shown outside their common container for purposes of the illustration;

FIG. 2 is a flow diagram illustrating methods of using a meal kit containing three possible meals according to several embodiments of the present invention;

FIG. 3 is a perspective view, partially broken away to show an inserted food pouch and integral pouch holder, of an alternative packaging approach for a meal kit of one embodiment of the invention; and

FIG. 4 is an exploded perspective view of another alternative approach for packaging a meal kit of another embodiment of the invention.

### DETAILED DESCRIPTION OF THE INVENTION

Meal kits are provided in embodiments of the present invention that provide fresh and savory meals while also providing the consumer ease, convenience, and flexibility with respect to the preparation requirements. The meal kit of the present invention provides all these characteristics in a single packaged meal kit with no requirements for addition of external food ingredients, such as meats, not included with the meal kit. The meal kit permits “one-stop” shopping for a savory meal by a consumer. The consumer enjoys a tasty meal while avoiding the inconvenience of having to prepare it from scratch or having to separately purchase and store addition ingredients necessary to complete the tasty meal.

Consumers having demanding schedules, while still need to feed themselves or the family, receive many benefits from using the meal kits according to embodiments of this invention. For instance, these consumers may have scheduling demands and challenges that restrict and which may vary the amount of time they have available to prepare meals. The meal kits according to embodiments of the present invention offer different preparation times to the consumer depending on which one of the multiple meal choices possible from the common meal kit is selected by the consumer. Consequently, the consumer has more flexibility to customize a meal choice selected from a meal kit to better fit the time restrictions and schedule of the consumer on that given occasion. In addition, each meal option or choice of a meal kit involves only a relatively small number of preparation steps, which adds to the convenience and ease of preparation. Also, the meal kits according to embodiments of this invention help solve the dinner dilemma or problem of a “taste restricted” household or “picky” eaters by offering multiple meal choices from a single meal kit.

In one embodiment, ingredients of the meal kit that may take longer to prepare and cook from scratch, such as meats, are at least substantially precooked before being packaged with the meal kit. This avoids the additional time and energy that otherwise would need to be devoted to shopping for the meat, cleaning it, chopping or cutting it, and cooking it from scratch.

In one embodiment, sanitary packaging techniques and equipment that are conventionally known and used can be used to package the precooked ingredients of the meal kits in a manner ensuring a refrigerated shelf life of at least multiple weeks without spoilage or significant organoleptic deterioration. For instance, the use of sanitary packaging techniques that exclude oxygen from the packaged food ingredients, and food packages having low oxygen permeability, including those known and available, makes refrigerated meal kits of the present invention remain fresh and ready to use for at least several weeks after purchase while avoiding the drawbacks associated with frozen meals. Shelf stable meal kits of other embodiments of the invention in which high moisture content food components of the kit, such as meat, are stably packaged in metal cans or in gas-barrier plastic containers generally provide even longer periods of time of fresh storage (e.g., about six to twelve months or even longer).

In addition, the meal kit eliminates the time and energy otherwise needed for measuring out the appropriate amounts of the various ingredients of a desired meal since that is already done for the given number of servings provided by the meal kit. The various packages of ingredients included in the meal kit merely need to be combined and cooked according to the instructions provided with the meal kit. In addition, each meal option of a meal kit involves only a relatively small number of preparation steps, which adds to the convenience and ease of preparation. In one embodiment, all ingredients included with the meal kit are used in implementing each of the meal options offered by that particular meal kit. In this manner, food waste is minimized and the consumer is not inconvenienced with storage of unused ingredients.

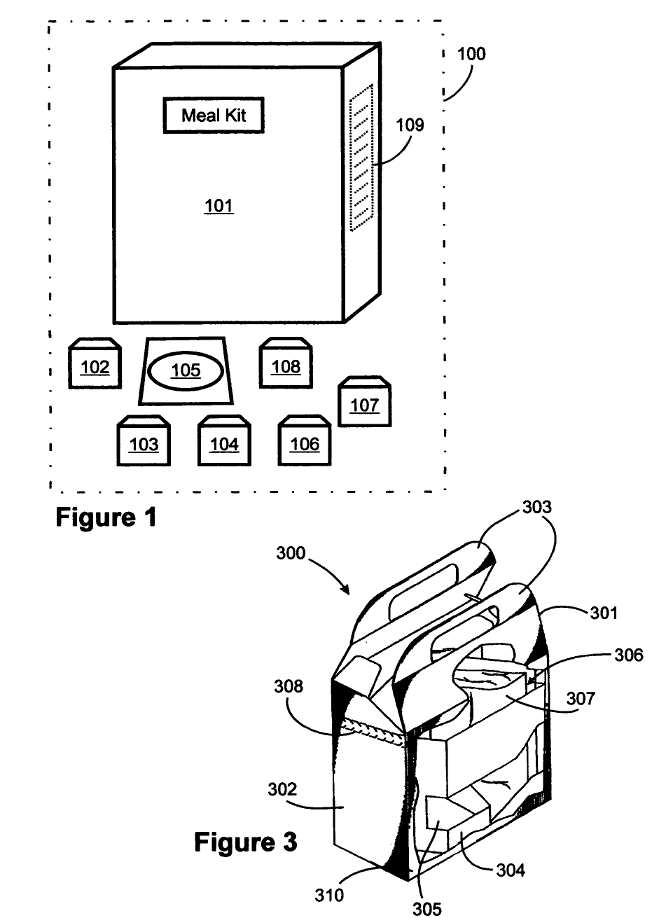

Referring to FIG. 1, in this non-limiting illustration, a meal kit 100 is depicted having individually packaged food components thereof, which are shown in this illustration as being taken out of their common container 101. The container 101 is used for packing, storage, display and handling of the meal kit 100. The food components in the meal kit 100 of this non-limiting illustration include a package 102 of precooked chicken strips packaged in a vacuum pouch; a package 103 of precooked (“no-boil”) Mexican rice; a package 104 of salsa; a package 105 of tortillas; a package 106 of peppers; a package 107 of onions; and a package 108 of shredded cheese. Instructions 109 are included on the container informing the consumer of the various multiple meal choices offered by the same meal kit; the associated preparation times for each available meal option; and the preparation steps associated with each available meal option.

When the consumer decides to prepare a meal from the meal kit, the consumer selects one of the meal options or choices available from the meal kit, as will be explained by the instructions and information included with the meal kit. The consumer removes the separate food or ingredient pouches or other containers from their common container at some point before the preparation of whatever meal is chosen. Based on the given meal choice made, the consumer follows the appropriate instructions for the selected meal. Depending on the specific instructions, the consumer may combine and cook, as appropriate, the food ingredients in cooking equipment and for cooking times or cook and then combine the various provided ingredients.

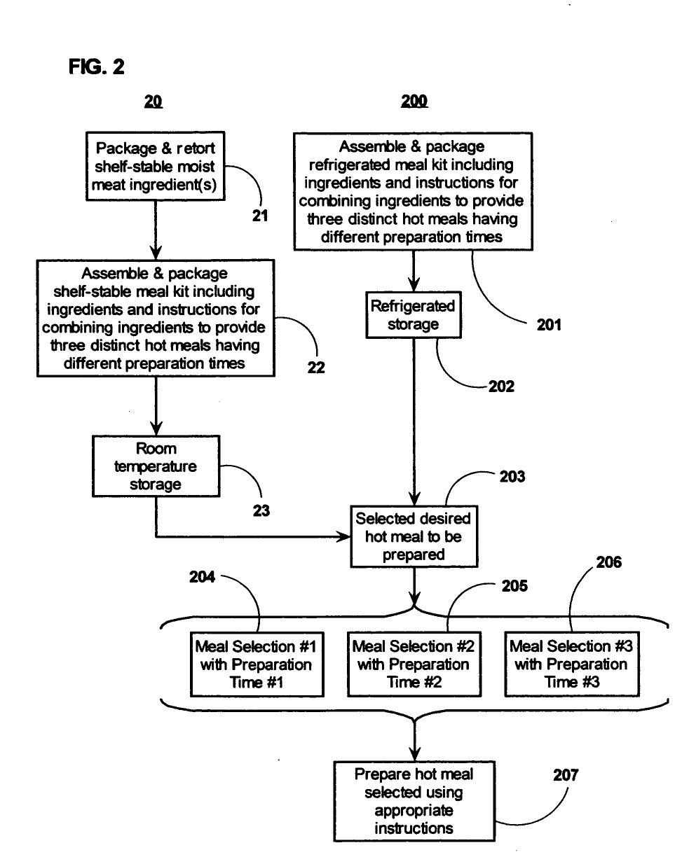

The meal kits of the present invention may be stably stored under either shelf stable conditions (i.e., ambient temperatures) or refrigerated conditions. FIG. 2 illustrates several methods for using the meal kits of this invention. Although three possible meal selections are illustrated in FIG. 2, the number of possible meal selections is at least two, and can, for example, be greater than the three illustrated. Method 200 in FIG. 2 illustrates the use of a refrigerated meal kit for preparing one of three different distinct hot meals using ingredients from the same meal kit according to an embodiment of the invention. In step 201, a meal kit is provided comprising an outer container, a plurality of ingredients in individual containers placed within the outer container, and a set of instructions contained on or within the outer container describing three different ways of combining the plurality of ingredients to form three distinct hot meals, wherein different non-overlapping preparation times are associated respectively with the three different ways of combining the plurality of ingredients. In step 202, the meal kit is refrigerated, preferably up until the time or approximately the time of preparation by a consumer. That is, the meal kit is not removed from refrigeration before preparing a meal for any period of time that would create a serious risk of spoilage or that otherwise would impair the quality of the ingredients. In step 203, a consumer selects one of the at least two distinct hot meals available from the same meal kit for preparation for consumption. The possible selections include meal selection #1 (204), meal selection #2 (205), and meal selection #3 (206). Once the appropriate meal has been selected, the consumer prepared the desired meal in step 207 in accordance with the set of instructions applicable to the selected meal choice (e.g., meal selections #1, #2, or #3 in FIG. 2). For example in a meal kit having three selections as shown in FIG. 2, meal selections #1, #2, and #3 are designed to have three different preparation times (i.e., preparation times #1, #2, and #3, respectively) using the same set of ingredients provided in the kit, so that a consumer, if desired, can factor the expected preparation time into his or her meal selection decision.

Referring still FIG. 2, alternative method 20 relates to a shelf stable meal kit according to an embodiment of the invention. In method 20, the meat ingredient or ingredients are packaged and retorted in step 21 to provide a room temperature stable product. In step 22, a meal kit is provided comprising an outer container, a plurality of ingredients in individual containers (including the packaged meat ingredients from step 21) placed within the outer container, and a set of instructions contained on or within the outer container describing at three different ways of combining the plurality of ingredients to form three distinct hot meals, wherein different non-overlapping preparation times are associated respectively with the three different ways of combining the plurality of ingredients. In step 23, the meal kit is stored under room temperature conditions until prepared by a consumer. The remaining steps in method 20 are the same as in method 200, although it will be appreciated that the preparation instructions and associated preparation times applicable to preparing one of several meal options from the shelf stable ingredients will not necessarily correspond to a refrigerated version of a similar assembled meal kit.

In shelf stable meal kits of embodiments of the present invention, greater attention generally may be given to the preparation and packaging of the high moisture content ingredients, especially moist meat-containing ingredients. In the shelf stable meal kits, freeze dried meat ingredients may be used that are rehydrated during meal preparation, such as by the moisture content of other ingredients included in the same meal kit. Alternatively, a meat ingredient of the shelf-stable meal kit can be precooked, completely or in part, and packaged in at least a partially moist state. For shelf stable meal kits of embodiments of this invention, precooked meat and/or other high moisture content food components of the meal kit may be individually packaged in gas-barrier containers suitable for storage at room temperatures (e.g., temperatures of about 65 to about 80° F.). The gas-barrier container can be a metal can or container that is hermetically sealed and then heated to thermally treat the food contents to ready it for shelf storage and handling. As an alternative hermetic package, the precooked meat can be packaged in a gas-barrier polymeric transparent or semitransparent container useful for room temperature storage conditions; preferably oxygen barrier multilayered packaging materials suitable for use in boil sterilization or retort sterilization procedures are used. For example, shelf stable polymeric packages preferably have oxygen permeabilities of less than about 1 cc/m²·day·atm. The shelf stable gas-barrier polymeric container can be in a pouch, rigid vessel, tray, or other convenient configuration. One commercial example of such gas-barrier packaging used in storage of meat at room temperature includes StarKist Flavor Fresh Pouch® containers for tuna.

It will be appreciated that the methods, ingredients, and containers depicted in the embodiments shown in the figures are merely illustrative and non-limiting. A meat component of the meal kit can include, for example, beef, fowl, pork, or fish. The meat is substantially precooked, such as by grilling, baking or frying, before it is packaged. The meat can be served as a cut strip or strips, or other pieces such as diced, minced, shaved, or formed into meat balls or other shapes. A starch component of the meal kit may be, for example, rice, pasta, potato, or combinations thereof. The potatoes can be, for example, diced, sliced, mashed, and so forth. Vegetable components can include, for example, green peppers, red peppers, yellow peppers, beans, bean sprouts, refried beans, onions, peas, water chestnuts, celery, carrots, corn, and so forth. Food components and ingredients also can be included which do not require cooking by the consumer, such as salsa, tortilla chips, taco shells, and so forth.

The prepared meal may also include a sauce component. The sauce component is selected based on the type of meal being produced. For example, the sauce component can be salsa, tomato sauce, gravy, white sauce, sweet and sour sauce, meat sauce, cheese sauce, cream sauce, marinara sauce, and so forth. Depending on the type of prepared meal being manufactured, the sauce component can come separately packaged in the meal or in combination with one or more of the other food components included in the package.

The various food components of the meal kit can be substantially precooked before or after packaging in the pouches or trays. The food components preferably will be cooked in a manner (i.e., at a temperature and for a duration) to provide an organoleptically desirable product and to adequately eradicate sufficient spoilage microorganisms, such as bacteria, yeasts, or molds, and any other types of undesirable microorganisms potentially present, to render the food wholesome and safe for consumption for at least the shelf life indicated or to be indicated on the product. For example, the meat component may a chicken strips that are substantially precooked, such as by grilling, before being hermetically packaged in a pouch, can, or other food container.

The inclusion of a beverage and/or a dessert as a side dish in the meal kit also are options. Of course, if a beverage and/or dessert is included with the meal kit, not all packaged ingredients would be used in the preparation of a meal choice in those instances.

In one embodiment, each of the food components of meal kits according to embodiments of the invention is separately hermetically sealed, separately wrapped, and/or separately compartmentalized. This helps ensure that there is no flavor transfer or other undesired transfer such as moisture and particulates between and among the individual food components. In one embodiment, the various components of the prepared meal are placed in separate pouches or trays that are then hermetically sealed. The plastic pouch or food container used in the practice of the invention preferably has a multilayer construction to essentially prevent all or only minuscule amounts of oxygen and chemicals from passing into or out of the pouch or tray through the plastic bag or tray. For example, co-extruded plastic film constructions are known that can be used in this manner.

In one aspect, the shelf life of the prepared meals is increased by processing the meals in a manner that reduces the amount of oxygen within the food package or pouch. One common method of reducing the oxygen within the package or pouch is to purge or gas flush the package or pouch with an inert gas, such as nitrogen, before filling it with a food component. Vacuum sealing methods also may be used to reduce the amount of oxygen present inside the pouches containing food components. Further details of this type of package are found, for example, in U.S. Pat. No. 5,747,084, the disclosure of which is incorporated by reference.

The refrigerated meal kits of embodiments of the present invention are kept under refrigeration after packaging up until preparation by a consumer. In general, the refrigeration temperature generally is in the range of between above 0 and about 7° C., and more particularly may be kept between above 0 and about 4° C. The shelf stable meal kits are designed to be stored at room temperature. All of the meal kits, whether designed for room temperature or refrigerated storage conditions, provide multiple meal options with different preparation times.

FIG. 3 shows an alternative arrangement for packaging a meal kit 300 of the invention in which the container 301 includes an outer container 302 preferably made of a rigid or semi-rigid foldable paperboard material and most preferably formed from a unitary monolithic blank. The container has an integral handle 303 for grasping, and internal divider strips or walls 304 that define separate compartments 305, 306 within the container for holding and preventing shifting of different food pouches or containers 307. This illustration is simplified by only showing two such storage compartments. It will be appreciated that storage compartments can be provided for as many food components as needed or desired. A portion of a tear strip 308, which can be of conventional construction for that function, is shown that can be grasped and torn by a consumer to open the container and provide access to the food pouches. The tear strip preferably is provided at a location around the box where it does not overlap meal choice information and associated meal preparation instructions. A pull drawer of conventional design, not shown, may be added to the carton front wall 310 to provide convenient access to the package interior. A fixed window, not shown, can be included in a wall of the container 301 using conventional techniques. Such product viewing windows can be formed by a die cut of the carton blank and it may be covered with a transparent film. These and other features of this type of container are described, for example, in commonly assigned U.S. Pat. No. 6,422,454 B1, which descriptions are incorporated herein by reference.

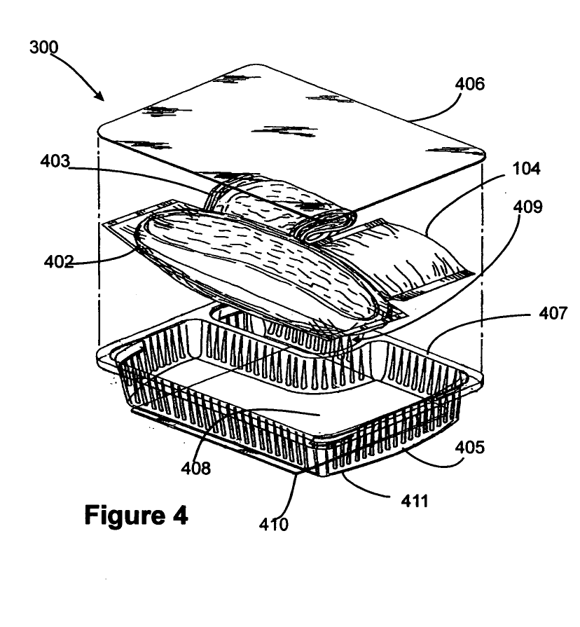

FIG. 4 shows another non-limiting alternative for packaging a meal kit 400 of the invention in which the container 401 used to package the ingredient pouches 402, 403, and 404, comprises a generally rigid base tray 405 and an oxygen-barrier flexible film cover 406 hermetically seals along a peripheral flange 407 of the rigid base tray 405. The various food components, such as packaged ingredients 402, 403, and 404 are hermetically sealed within compartments 408 and 409 defined by the base tray 405 and the film cover 406. To simplify this illustration, only several food pouches are shown, but it will be appreciated that any convenient number could be used.

The base tray 405 generally is a rigid or semi-rigid type. The base tray materials are typically polymeric, and they exhibit stiffness, but are not too stiff so that they could be easily damaged or dented during handling. The materials also must satisfy the basic function of preserving the quality of the food products by minimizing any transference when in a hermetically sealed condition. High impact polystyrene and high density polyethylene can be suitable components of multi-layer extrusion. Specific examples include, for example, multi-layer constructions including high impact polystyrene, inner and outer layers of low density polyethylene, one or more ethylene vinyl alcohol or polyvinylidene oxygen-barrier inner layers, and a layer of anti-fogging agent.

The oxygen-barrier cover 406 preferably is a flexible transparent film sheet cover. Polyester materials can be especially useful for this top or cover because they are relatively strong and can accept ink or labels quite well. For example, the meal choices and preparation instructions of the meal kit can be provided in printed ink form or via labeling information 410 on the base tray 405, such as its external bottom side 411, and/or on the cover 406. Multi-layer films also can be used for cover 406, such as including an oxygen barrier middle layer including materials such as ethylene vinyl alcohol and polyvinylidene dichloride. A particular useful interior layer is low density polyethylene which is heat sealable and provides a moisture barrier and can accept an anti-fogging agent. The flexible film cover 406 is air-tightly sealed to the peripheral flange 407 of base tray 405 by heat-sealing, suitable adhesives, and the like. During the course of the sealing operation, preferably the package is gas-flushed in accordance with generally known techniques prior to or as being sealed. Various ones of the food pouches 402, 403, and 404 will be separately packaged under gas-flushing or vacuum sealing conditions before being placed in the base tray compartments 408 and 409. Retort pouches can, if desired, be used and the packaged contents heated to elevated temperature (e.g., about 105 to about 140° C.) before Packaging materials and techniques useful in this regard are described and referenced, for example, in U.S. Pat. No. 6,048,558, which descriptions are incorporated by reference.

Non-limiting examples of different types of refrigerated meal kits according to embodiments of the invention, include, for instance:

A. A Mexican chicken dinner kit. A consumer preparing a meal from this kit can select between making a 1) chicken skillet dinner in about 10 minutes; or 2) chicken fajitas in about 15 minutes; or 3) baked chicken enchiladas in about 25 minutes. The packaged contents could include pregrilled southwest chicken breast strips; green peppers; onions; no-boil Mexican rice; salsa; tortillas; and shredded cheese blend.

B. An Italian dinner kit. It makes 1) Italian quesadilla, or 2) ravioli, or 3) lasagna. These three types of dinners from which the consumer can choose for preparation each use all of the ingredients included in the meal kit, and they can be prepared in different non-overlapping preparation times. The packaged contents could include browned ground beef crumbs; green peppers, onions; Italian foccacia sheets; marinara sauce; seasoned ricotta cheese; shredded mozzarella and Parmesan cheese.

C. An American chicken dinner kit. It makes 1) stew, or 2) skillet casserole, or 3) baked chicken and rice. These three types of dinners from which the consumer can choose for preparation also each use all of the ingredients included in the meal kit, and they can be prepared in different non-overlapping preparation times. The packaged contents could include grilled chicken breast strips; carrots; peas; no-boil white rice; chicken broth concentrate; shredded cheddar cheese.

D. A Mexican beef dinner kit. It makes 1) tacos, or 2) burritos, or 3) Mexican pizza. These three types of dinners from which the consumer can choose for preparation also each use all of the ingredients included in the meal kit, and they can be prepared in different non-overlapping preparation times. The packaged contents could include browned ground beef crumbs; black olives; onions; refried beans; salsa; tortillas; shredded cheese blend.

E. An Asian Teriyaki dinner kit. It makes 1) skillet spring rolls, or 2) chicken fried rice, or 3) layered Asian Teriyaki casserole. These three types of dinners from which the consumer can choose for preparation also each use all of the ingredients included in the meal kit, and they can be prepared in different non-overlapping preparation times. The packaged contents could include Teriyaki chicken breast strips; green peppers; onions; no-boil white rice; stir-fry sauce; sliced water chestnuts; Asian wraps.

Non-limiting examples of different types of meal kits suitable for room temperature storage according to embodiments of the invention, include, for instance, a Mexican chicken dinner kit, wherein a consumer preparing a meal from this kit can select between making a 1) chicken skillet dinner in about 10 minutes; or 2) chicken fajitas in about 15 minutes; or 3) baked chicken enchiladas in about 25 minutes. The content of such a shelf stable kit could include grilled chicken strips packaged in a retort pouch or can; vegetables in salsa sauce; fully cooked rice (acidified); tortillas; and shredded dry cheese (e.g., Parmesan or other cheese).

The following example is intended to illustrate the invention and not to limit it.

### EXAMPLE

A Mexican dinner kit meal according to an embodiment of the invention provides three choices for types of meals that can be prepared using all the ingredients included in the meal kit. The packaged contents include pregrilled southwest chicken breast strips; green peppers; onions; no-boil Mexican rice; salsa; tortillas; and shredded cheese blend. These meal choices and associated preparation times and steps are as follows.

(1) Skillet Dinner:

Preparation Time: 10 minutes
1. Heat chicken, vegetables, rice, and salsa together in skillet,
2. Top with cheese, and
3. Warm tortillas and serve on the side.
   (2) Fajitas with Rice:

Preparation Time: 15 minutes
1. Heat chicken, vegetables and salsa in skillet,
2. Use heated ingredients and cheese as filling for fajitas, and
3. Heat rice and serve on the side.
   (3) Baked Chicken Enchiladas:

Preparation Time: 25 minutes
1. Heat chicken, vegetables, rice, and half the salsa in skillet,
2. Spoon heated ingredients into tortillas, roll up and place in baking dish, and
3. Top with remaining salsa and cheese and bake for 10 minutes.

While the invention has been described in terms of preferred embodiments, those skilled in the art will recognize that the invention can be practiced with modification within the spirit and scope of the appended claims.

1. A meal kit for preparing at least two distinct hot meals, said meal kit comprising an outer container, a plurality of ingredients in individual containers placed within the outer container, and a set of instructions contained on or within the outer container describing at least two different ways of combining the plurality of ingredients to form at least two distinct hot meals, wherein different non-overlapping preparation times are associated respectively with the at least two different ways of combining the plurality of ingredients to make the at least two distinct hot meals.

2. The meal kit as defined in claim 1, wherein the instructions provide directions for preparing each of the at least two distinct hot meals using all of the plurality of ingredients in each of the at least two distinct hot meals.

3. The meal kit as defined in claim 1, wherein the plurality of ingredients include a substantially cooked meat ingredient.

4. The meal kit as defined in claim 1, wherein the plurality of ingredients can be combined in at least three different ways to form at least three distinct hot meals.

5. The meal kit as defined in claim 1, wherein the plurality of ingredients includes precooked meat, precooked vegetables, a starch product, cheese, sauce, and a bread product.

6. The meal kit as defined in claim 2, wherein the plurality of ingredients includes precooked meat, precooked vegetables, a starch product, cheese, sauce, and a bread product.

7. The meal kit as defined in claim 5, wherein the precooked meat comprises chicken, the starch product comprises rice, the sauce comprises salsa, and the bread product comprises flatbread.

8. The meal kit as defined in claim 6, wherein the precooked meat comprises chicken, the starch product comprises rice, the sauce comprises salsa, and the bread product comprises flatbread.

9. The meal kit as defined in claim 7, wherein the flatbread comprises a tortilla.

10. The meal kit as defined in claim 8, wherein the flatbread comprises a tortilla.

11. The meal kit as defined in claim 8, wherein the at least two distinct hot meals are selected from the group consisting of a skillet dinner, fajitas with rice, and enchiladas.

12. The meal kit as defined in claim 9, wherein the at least two distinct hot meals are selected from the group consisting of a skillet dinner, fajitas with rice, and enchiladas.

13. The meal kit as defined in claim 1, wherein the plurality of ingredients are separately packaged in individual packages in a sanitary manner in packages resistant to oxygen permeation, and the packages are enclosed within a common container.

14. The meal kit as defined in claim 1, wherein the plurality of ingredients are stored under refrigeration conditions until combined.

15. The meal kit as defined in claim 1, wherein the plurality of ingredients are stored under room temperature conditions until combined.

16. A three-in-one meal kit for preparing three distinct hot meals, said meal kit comprising an outer container, a plurality of ingredients in individual containers placed within the outer container, and a set of instructions contained on or within the outer container describing three different ways of combining the plurality of ingredients to form three distinct hot meals, wherein different non-overlapping preparation times are associated respectively with the three different ways of combining the plurality of ingredients to make the three distinct hot meals.

17. The three-in-one meal kit as defined in claim 16, wherein the instructions provide directions for preparing each of the three distinct hot meals using all of the plurality of ingredients in each of the three distinct hot meals.

18. The three-in-one meal kit as defined in claim 16, wherein the plurality of ingredients include a substantially cooked meat ingredient.

19. The three-in-one meal kit as defined in claim 16, wherein the plurality of ingredients includes precooked meat, precooked vegetables, a starch product, cheese, sauce, and a bread product.

20. The three-in-one meal kit as defined in claim 19, wherein the precooked meat comprises chicken, wherein the starch product comprises rice, the sauce comprises salsa, and the bread product comprises a tortilla.

21. The three-in-one meal kit as defined in claim 20, wherein the three distinct hot meals include a skillet dinner, fajitas with rice dinner, and enchilada dinner.

22. The three-in-one meal kit as defined in claim 21, wherein the skillet dinner is adapted to be prepared by heating the chicken, vegetables, rice, and salsa together to form a heated first mixture, topping the heated first mixture with the cheese, and heating the tortilla to be served on the side; wherein the fajitas with rice dinner is adapted to be prepared by heating the chicken, vegetables, and salsa to form a heated second mixture, filling the tortilla with the heated second mixture and the cheese to form fajitas, and heating the rice to be served on the side; and wherein the enchilada dinner is adapted to be prepared by heating the chicken, vegetables, rice, and a portion of the salsa to form a heated third mixture, placing the heated third mixture in the tortilla, rolling up the tortilla containing the heated third mixture to form an enchilada, topping the enchilada with cheese and remainder of the salsa to form the dinner, and baking the dinner.

23. The three-in-one meal kit as defined in claim 19, wherein the precooked meat comprises beef, the sauce comprises salsa or taco sauce, and the bread product is a tortilla or a taco shell.

24. The three-in-one meal kit as defined in claim 16, wherein the plurality of ingredients are separately packaged in individual packages in a sanitary manner in packages resistant to oxygen permeation, and the packages are enclosed within a common container.

25. The three-in-one meal kit as defined in claim 16, wherein the plurality of ingredients are stored under refrigeration conditions until combined.

26. The three-in-one meal kit as defined in claim 16, wherein the plurality of ingredients are stored under room temperature conditions until combined.

27. A method for using a meal kit for preparing one of at least two distinct hot meals using ingredients from the same meal kit, comprising:
(a) providing a meal kit comprising an outer container, a plurality of ingredients in individual containers placed within the outer container, and a set of instructions contained on or within the outer container describing at least two different ways of combining the plurality of ingredients to form at least two distinct hot meals, wherein different non-overlapping preparation times are associated respectively with the at least two different ways of combining the plurality of ingredients to make at least two distinct hot meals;
(b) storing the meal kit under appropriate conditions until it is desired to prepare the meal kit;
(c) selecting one of the at least two distinct hot meals for preparation; and
(d) preparing the selected distinct hot meal in accordance with the set of instructions insofar as the instructions applicable to the selected meal choice.

28. The method of claim 27, wherein the instructions provide directions for preparing each of the at least two distinct hot meals using all of the plurality of ingredients in each of the at least two distinct hot meals.

29. The method of claim 27, wherein the plurality of ingredients include a substantially cooked meat ingredient.

30. The method of claim 27, wherein the plurality of ingredients are separately packaged in individual packages in a sanitary manner in packages resistant to oxygen permeation.

31. The method of claim 27, wherein the appropriate conditions for storing are at refrigeration temperatures of between above 0 and about 4° C.

32. The method of claim 27, wherein the appropriate conditions for storing are at room temperature.
